(19) United States
(12) Patent Application Publication
(10) Pub. No.: US 2006/0087511 A1
(43) Pub. Date: Apr. 27, 2006

(54) Computer and graphic card detachably connected thereto

(75) Inventor: Man-hee Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/251,757

(22) Filed: Oct. 18, 2005

(30) Foreign Application Priority Data
Oct. 18, 2004 (KR) 2004-83289

(51) Int. Cl. G06F 13/14

(52) U.S. Cl. 345/520

(57) ABSTRACT

The present invention relates to a computer including a first output port, a first video signal generator to generate a first video signal having a predetermined format, a second video signal generator detachably connected to the computer and to generate a second video signal having the same format as the first video signal; and an output selector to output at least one of the first video signal and/or the second video signal through the first output port when the second video signal generator is connected to the computer. Thus, the present invention provides a computer with a low profile graphic card, which enables implementation of a dual monitor and promotes space utilization of a motherboard.

### CROSS-REFERENCE TO RELATED APPLICATIONS

This application claims the benefit of Korean Patent Application No. 2004-0083289, filed on Oct. 18, 2004, in the Korean Intellectual Property Office, the disclosure of which is incorporated herein by reference.

### BACKGROUND OF THE INVENTION

1. Field of the Invention

The present invention relates to a computer and, more particularly, to a computer with a low profile graphic card, which enables implementation of a dual monitor and promotes improved space utilization of a motherboard.

2. Description of the Related Art

Generally, a computer system comprises a main body provided with a graphic card to generate a video signal, and a monitor connected to the graphic card provided in the main body to display a picture based on the video signal transmitted from the graphic card.

The graphic card is classified into an internal graphic card mounted on the motherboard, and an external graphic card detachably connected to a slot on the motherboard. Generally, the internal graphic card is disabled while the external graphic card is in use, and vice versa.

FIG. 1 illustrates a configuration of a conventional motherboard mounted with an internal graphic card.

As illustrated therein, a motherboard 100 includes a main chipset 102 functioning as the internal graphic card to generate red, green and blue (RGB) signals, RGB signal lines 106 transmitting the RGB signals generated from the main chipset 102, and an internal RGB port 104 receiving the RGB signals through the RGB signal lines 106 and outputting them to the monitor.

Thus, the RGB signals generated by the main chipset 102 are outputted to the internal RGB port 104 through the RGB signal lines 106.

However, there is a limit to the graphic performance of the internal graphic card, so that the external graphic card is frequently used in order to compensate for the limit in the graphic performance in cases when only the internal graphic card is used.

In the external graphic card, a digital video interface (DVI) port 116 and an external RGB port 118 are all provided (refer to FIG. 2), or either a DVI port 144 or an RGB port (not shown) is provided (refer to FIG. 3)

As illustrated in FIG. 2, the external graphic card 110 that is provided with both the DVI port 116 and the external RGB port 118 is generally used to implement a conventional dual monitor in a desktop computer. Such an external graphic card 110 includes a graphic controller 112 to generate a DVI signal and an RGB signal. The DVI port 116 and the external RGB port 118 are used to transmit the DVI signal and the RGB signal generated from the graphic controller 112, respectively, and an accelerated graphics port (AGP) interface line 114a provides an AGP interface between a motherboard 120 and the external graphic card 110.

In FIG. 2, the motherboard 120 includes a main chipset 122 functioning as the internal graphic card to generate an RGB signal, an RGB signal line 126 to transmit the RGB signal generated by the main chipset 122, an internal RGB port 124 to transmit the RGB signal from the RGB signal line 126 to the monitor, the AGP interface line 114b providing the AGP interface between the graphic controller 113 of the external graphic card 110 and the main chipset 122, and an AGP slot 119 to which the external graphic card 110 is connected so as to connect the AGP interface line 114b of the motherboard 120 with an AGP interface line 114a of the external graphic card 110.

When the external graphic card 110 is connected to the AGP slot 119 of the motherboard 120, the function of the internal graphic card in the main chipset 122 is disabled. Therefore, the RGB signal is not outputted through the RGB signal line 126 of the motherboard 120, and the graphic controller 112 of the external graphic card 110 communicates with the main chipset 122 through the AGP interface lines 114a and 114b. The DVI and RGB signals generated by the graphic controller 112 are outputted through the DVI port 116 and the external RGB port 118, respectively.

Thus, a monitor having an interface corresponding to the DVI port 116 and a monitor having an interface corresponding to the external RGB port 118 are connected to the DVI port 116 and the external RGB port 118, respectively, thereby making the implementation of a dual monitor system possible.

However, in the case of a widespread slim computer, there is a limit to a space of the slim computer, so that the size of the external graphic card should be decreased corresponding to the size of the main body. Thus, the external graphic card for the slim computer cannot comprise both the DVI port and the RGB port.

Accordingly, the external graphic card for the slim computer generally includes either the DVI port or the RGB port. Such an external graphic card for the slim computer is generally called “low profile graphic card”.

FIG. 3 illustrates connection between the external graphic card including only a DVI port 144 and the motherboard 130 in the conventional slim computer.

As illustrated therein, the external graphic card 140 includes a graphic controller 142 to generate the DVI signal and the RGB signal, the DVI port 144 to transmit the DVI signal from the graphic controller 142 to the monitor, and an AGP interface line 138a providing an AGP interface between the motherboard 130 and the external graphic card 140.

The motherboard 130 of FIG. 3 has the same configuration as that of FIG. 2, so that repetitive descriptions will be avoided as necessary.

When the external graphic card 140 is connected to an AGP slot 139 of the motherboard 130, function of the internal graphic card in the main chipset 132 is disabled. Therefore, the RGB signal is not outputted to an internal RGB port 134 through the RGB signal line 136 of the motherboard 130, and the graphic controller 142 of the external graphic card 140 communicates with the main chipset 132 through the AGP interface lines 138a and 138b. Only the DVI signal generated by the graphic controller 142 is outputted through the DVI port 144.

In this case, there is no port for the RGB signal generated by the graphic controller 142. Therefore, in the case of the low profile graphic card 140 shown in FIG. 3, it is impossible to realize the dual monitor system.

Further, in the case of the external graphic card 140 shown in FIG. 3, the internal RGB port 134 can be removed from the motherboard 130, so that space utilization of the motherboard 130 is deteriorated.

### SUMMARY OF THE INVENTION

Accordingly, it is an aspect of the present invention to provide a computer with a low profile graphic card, which enables implementation of a dual monitor and promotes space utilization of a motherboard.

The foregoing and/or other aspects of the present invention are also achieved by providing a computer including a first output port, a first video signal generator to generate a first video signal having a predetermined format, a second video signal generator detachably connected to the computer and to generate a second video signal having the same format as the first video signal, and an output selector to output either the first video signal and/or the second video signal through the first output port when the second video signal generator is connected to the computer.

According to another aspect of the present invention, the computer further includes a motherboard, and an interface provided in the motherboard and to which the second video signal generator is detachably connected, wherein the first video signal generator is disabled and the output selector outputs the second video signal through the first output port when the second video signal generator is connected to the interface.

According to another aspect of the present invention, the output selector includes a first path to transmit the first video signal generated from the first video signal generator to the first output port, and a second path to transmit the second video signal generated from the second video signal generator to the first output port.

According to another aspect of the present invention, the second path connects the second video signal generator with the first output port via the interface.

According to another aspect of the present invention, the second path is branched from the first path and connected to the second video signal generator through the interface.

According to another aspect of the present invention, the computer further includes a resistor provided on the second path and having resistance of a predetermined level or less.

According to another aspect of the present invention, the first and second video signals have an analog-type format.

According to another aspect of the present invention, the second video signal generator further generates a third video signal different in format from the second video signal, and includes a second output port to transmit the third video signal.

According to another aspect of the present invention, the third video signal has a digital-type format.

According to another aspect of the present invention, the output selector includes a controller to sense whether the second video signal generator is connected to the computer, and to output the first video signal through the first output port when the second video signal generator is connected to the computer.

According to another aspect of the present invention, the computer further includes a motherboard, and an interface that is provided in the motherboard, to which the second video signal generator is detachably connected, and which generates an attachment/detachment sensing signal according to whether the second video signal generator is connected to the interface, wherein the controller determines whether the second video signal generator is connected to the interface on the basis of the attachment/detachment sensing signal generated by the interface, and controls the first video signal to be outputted through the first output port when the second video signal generator is connected to the interface.

The foregoing and/or other aspects of the present invention are also achieved by providing a graphic card that is detachably connected to the computer, including an output port, an interface having a plurality of signal pins for communicating with the computer, and a graphic controller that generates first and second videos signals different in format from each other on the basis of data transmitted from the computer through the interface, outputs the first video signal through the output port, and outputs the second video signal to the computer through at least some signal pins among a plurality of signal pins provided in the interface.

According to another aspect of the present invention, the interface supports an AGP interface.

According to another aspect of the present invention, the second video signal is outputted from the graphic controller to the computer through at least one of the signal pins among the plurality of signal pins provided in the interface except the signal pins for data communication that uses the AGP interface.

According to another aspect of the present invention, the first video signal has one format of an analog-type and a digital-type, and the second video signal has the other format.

Another aspect of the present invention is achieved by providing a computer method including generating a first video signal having a predetermined format and generating a second video signal having the same format as the generated first video signal, and outputting at least one of the generated first video signal and/or the generated second video signal through an output port when the generated second video signal is connected to a computer.

Another aspect of the present invention is achieved by providing a method, including mounting an external graphic card to a computer, outputting a digital video interface (DVI) signal through a first port, generating a RGB signal and outputting said RGB signal through a second port; and implementing a dual monitor through said second port.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 illustrates a configuration of a conventional motherboard mounted with an internal graphic card;

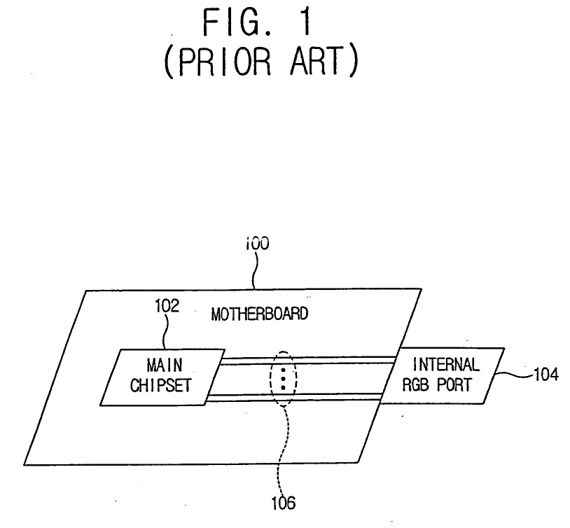

FIG. 2 illustrates connection between an external graphic card and a motherboard for a dual monitor in a conventional desktop computer;

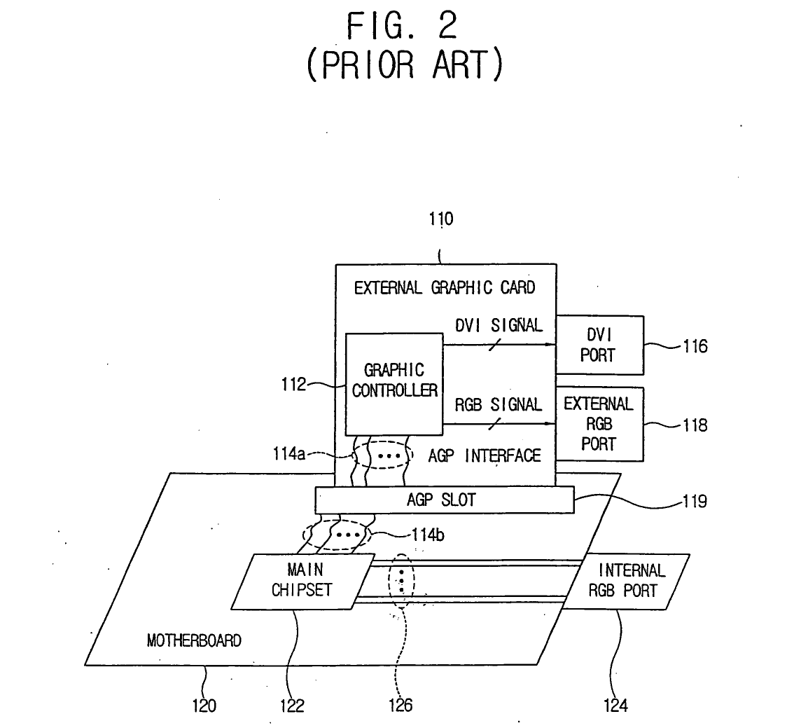

FIG. 3 illustrates connection between an external graphic card and a motherboard in a conventional slim computer;

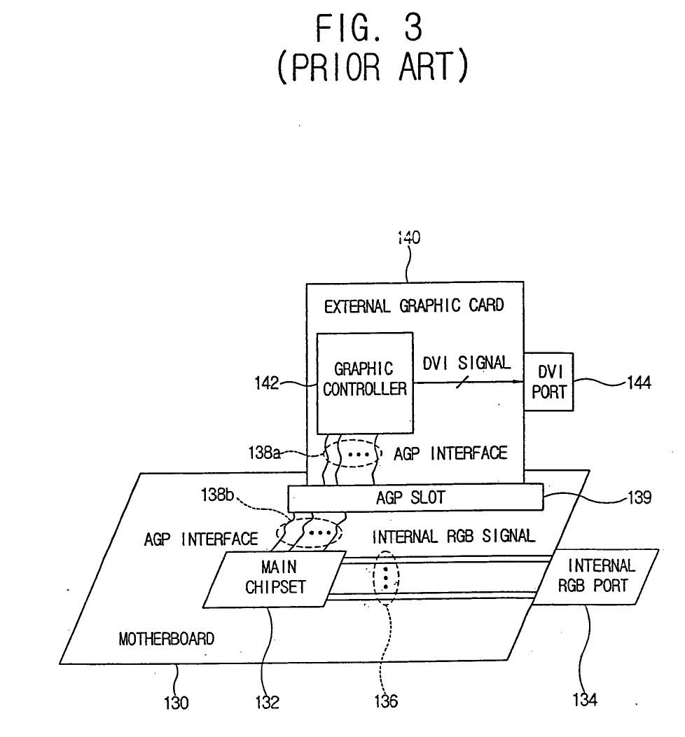

FIG. 4 illustrates connection between an external graphic card and a motherboard in a computer according to a first embodiment of the present invention;

FIG. 5 illustrates an AGP slot according to the first embodiment of the present invention;

FIG. 6 illustrates a specific signal line connection between the AGP slot and its peripheral circuitry according to the first embodiment of the present invention; and

FIG. 7 is a control block diagram of a computer according to a second embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

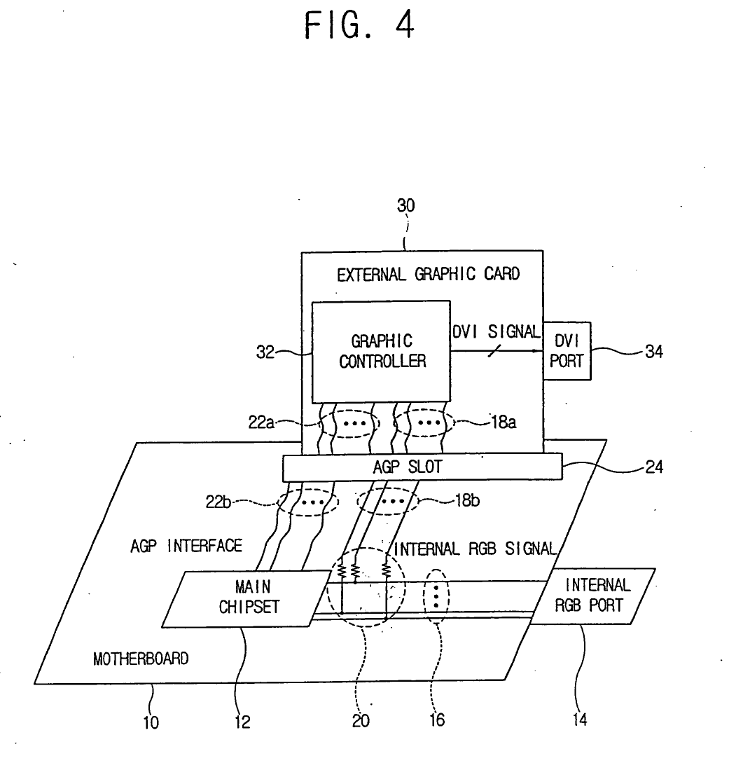

FIG. 4 illustrates the connection between an external graphic card and a motherboard in a computer according to a first embodiment of the present invention. As shown therein, a computer according to the first embodiment of the present invention comprises a motherboard 10 having an AGP slot 24 used as an interface, and an external graphic card 30 detachably connected to the AGP slot 24 of the motherboard 10. According to an embodiment of the present invention, the external graphic card 30 includes a low profile graphic card having, for example, only a DVI port 34.

The external graphic card 30 comprises a graphic controller 32 that is used to generate an RGB signal (hereinafter, referred to as “external RGB signal”) and a DVI signal as video signals. A DVI port 34 is used to transmit the DVI signal generated from the graphic controller 32 to a monitor. An AGP interface line 22a forms an AGP interface between the motherboard 10 and the graphic controller 32, and an external RGB signal line 18a is used as a second path for transmitting the external RGB signal generated from the graphic controller 32.

The motherboard 10 comprises a main chipset 12 functioning as an internal graphic card that is used to generate an RGB signal (hereinafter, referred to as “internal RGB signal”) as a video signal, an internal RGB signal line 16 that is used as a first path for transmitting the internal RGB signal generated from the main chipset 12, an internal RGB port 14 to transmit the internal RGB signal transmitted through the internal RGB signal line 16 to the monitor, and an AGP interface line 22b to form an AGP interface between the main chipset 12 and the graphic controller 32 of the external graphic card 30.

Further, the motherboard 10 comprises an external RGB signal line 18b used as the second path for transmitting the external RGB signal that is generated by the graphic controller 32 of the external graphic card 30 to the internal RGB signal line 16 through the AGP slot 24. The AGP slot 24 connects the AGP interface line 22b of the motherboard 10 with the AGP interface 22a of the external graphic card 30, and also connects the external RGB signal line 18a of the external graphic card 30 with the external RGB signal line 18b of the motherboard 10 when the external graphic card 30 is connected to the motherboard 10. A resistor 20 is also connected to the external RGB signal line 18b.

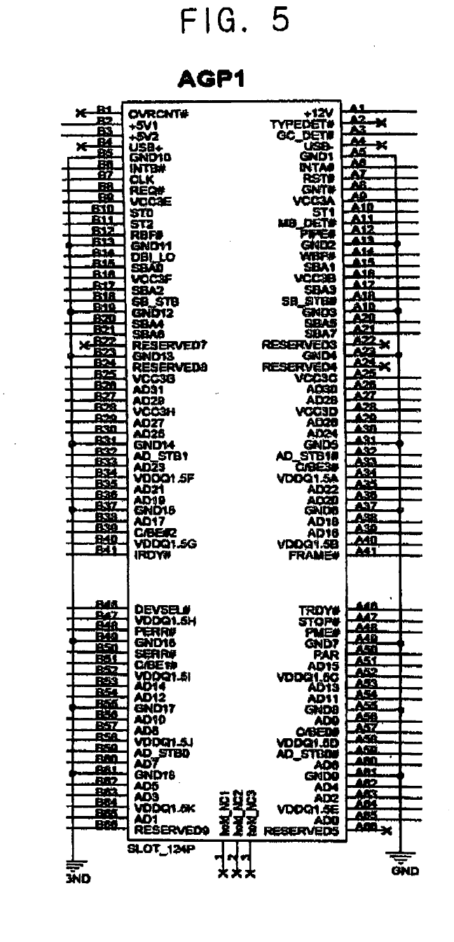

In the case of the typical motherboard, the AGP slot has a plurality of surplus pins that are seldom used (refer to a mark of “X” in FIG. 5).

According to an embodiment of the present invention, the external RGB signal line 18a is provided for allowing the external RGB signal generated by the graphic controller 32 of the external graphic card 30 to be outputted through such surplus pins of the AGP slot 24. Further, the external RGB signal line 18b used as the second path branched from the internal RGB signal line 16 formed on the motherboard 10 is routed for allowing the RGB signal passing through both the external RGB signal line 18a provided in the external graphic card 30 and the AGP slot 24 to be outputted to the internal RGB port 14 through the internal RGB signal line 16. Thus, the main chipset 12 outputs the external RGB signal through the internal RGB port 14 when the external graphic card 30 is connected to the motherboard 10.

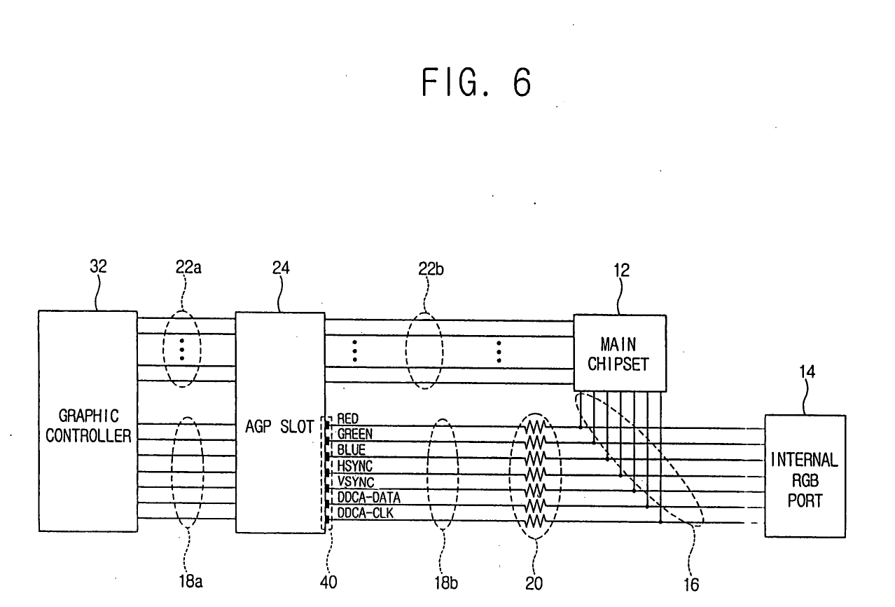

FIG. 6 illustrates a specific signal line connection between the AGP slot and its peripheral circuitry according to the first embodiment of the present invention.

As shown therein, the graphic controller 32 is connected to the AGP slot 24 through the AGP interface lines 22a, and the external RGB signal lines 18a (RED, GREEN, BLUE, HSYNC, VSYNC, DDCA_DATA, DDCA_CLK). Further, the AGP slot 24 is connected to the main chipset 12 through the AGP interface line 22b. Also, the AGP slot 24 is connected to the internal RGB port 14 through the external RGB signal line 18b. The external RGB signal lines 18a and 18b are connected to each other through the surplus pins 40 of the AGP slot 24, and are routed in a branched fashion from the internal RGB signal line 16, thereby being connected to the internal RGB port 14.

The resistor 20 connected to the external RGB signal line 18b is employed to prevent a stub effect from arising on the internal RGB signal line 16. Preferably, the resistor 20 has a resistance of close to 0 Ω. Further, the resistor 20 is preferably connected to the external RGB signal line 18b when the external graphic card 30 is used. Otherwise, the resistor is not connected.

With this configuration, when the external graphic card 30 is connected to the motherboard 10 in the computer according to an embodiment of the present invention, the video signal is transmitted as described hereinafter. When the external graphic card 30 is inserted into the AGP slot 24 of the motherboard 10, the main chipset 12 does not function as the internal graphic card. Therefore, the internal RGB signal is not outputted through the internal RGB signal line 16 of the motherboard 10.

On the other hand, the graphic controller 32 of the external graphic card 30 communicates with the main chipset 12 by the AGP interface lines 22a and 22b. Further, the DVI signal generated in the graphic controller 32 is outputted to the DVI port 34. Also, the RGB signal generated in the graphic controller 32 is outputted to the internal RGB port 14 through both the external RGB signal lines 18a and 18b and the internal RGB signal line 16 connected with the external RGB signal lines 18a and 18b.

Thus, when the external graphic card 30 is mounted to the slim computer, the DVI signal is outputted through the DVI port 34 of the external graphic card 30, and the RGB signal generated in the graphic controller 32 is outputted through the internal RGB port 14 of the motherboard 10, thereby enabling implementation of a dual monitor and enhancing utilization by using the existing internal RGB port 14.

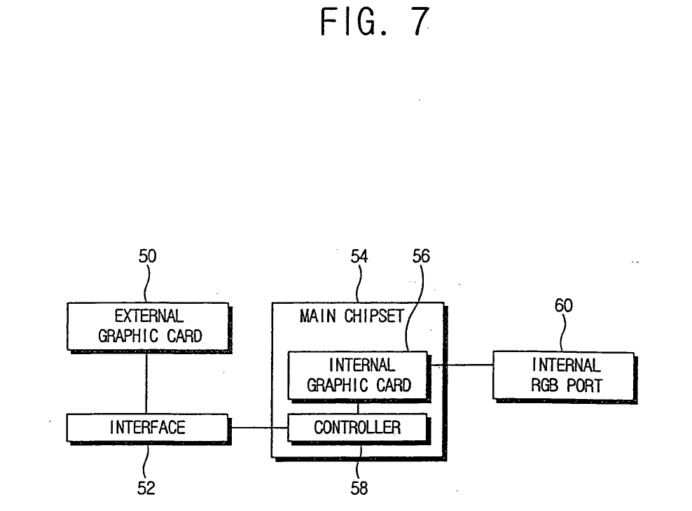

FIG. 7 is a control block diagram of a computer according to a second embodiment of the present invention. As illustrated therein, a computer according to the second embodiment of the present invention comprises an interface 52, an external graphic card 50 detachably connected to the interface 52 and having a DVI port (not shown), a main chipset 54 that functions as an internal graphic card 56 for generating an internal RGB signal and as a controller 58. The internal RGB port 60 is for outputting the internal RGB signal.

The interface 52 includes an AGP slot or a peripheral component interconnect (PCI)-express slot, to which the external graphic card 50 is detachably connected. The interface 52 generates an attachment/detachment sensing signal when the external graphic card 50 is attached thereto or detached therefrom.

The external graphic card 50 generates the RGB signal and the DVI signal in different formats from each other. The DVI signal is outputted through a DVI port (not shown) provided in the external graphic card 50.

The main chipset 54 generates the internal RGB signal and outputs it through the internal RGB port 60 when it is determined that the external graphic card 50 is connected to the interface 52 on the basis of the attachment/detachment sensing signal generated by the interface 52.

Thus, when the external graphic card 50 is mounted to the computer according to the second embodiment of the present invention, the DVI signal is outputted through the DVI port of the external graphic card 50, and the RGB signal generated in the main chipset 54 is outputted through the internal RGB port 60, thereby enabling the implementation of a dual monitor

According to an embodiment of the present invention, the main chipset 12, 54 is used as an output selector to output the external RGB signal or the internal RGB signal through the internal RGB port 14, 60 when the external graphic card 30 or 50 is mounted.

In the foregoing embodiment, the external graphic card includes an AGP card, but is not limited to this configuration, and the external graphic card may include a PCI express card connected to a PCI express slot.

In the foregoing embodiment, the motherboard and the external graphic card are provided with the RGB port and the DVI port as an output port, respectively, but are not limited to this configuration. Alternatively, each of the motherboard and the external graphic card may be provided with one of various video output ports.

Thus, when the external graphic card is mounted to the computer, the computer outputs the video signal generated from either the external graphic card or the internal graphic card through the output port provided in the motherboard, thereby enabling the implementation of the dual monitor.

As described above, the present invention provides a computer with a low profile graphic card, which not only enables the implementation of a dual monitor but also promotes space utilization of a motherboard.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer, comprising:
a first output port;
a first video signal generator to generate a first video signal having a predetermined format;
a second video signal generator detachably connected to the computer and to generate a second video signal having the same format as the first video signal; and
an output selector to output at least one of the first video signal and/or the second video signal through the first output port when the second video signal generator is connected to the computer.

2. The computer according to claim 1, further comprising a motherboard, and an interface provided in the motherboard and to which the second video signal generator is detachably connected, wherein
the first video signal generator is disabled and the output selector outputs the second video signal through the first output port when the second video signal generator is connected to the interface.

3. The computer according to claim 2, wherein the output selector comprises a first path to transmit the first video signal generated from the first video signal generator to the first output port, and a second path to transmit the second video signal generated from the second video signal generator to the first output port.

4. The computer according to claim 3, wherein the second path connects the second video signal generator with the first output port via the interface.

5. The computer according to claim 4, wherein the second path is branched from the first path and connected to the second video signal generator through the interface.

6. The computer according to claim 5, further comprising a resistor provided on the second path and having resistance of a predetermined level or less.

7. The computer according to claim 1, wherein the first and second video signals have an analog-type format.

8. The computer according to claim 1, wherein the second video signal generator further generates a third video signal different in format from the second video signal, and comprises a second output port to transmit the third video signal.

9. The computer according to claim 8, wherein the third video signal has a digital-type format.

10. The computer according to claim 1, wherein the output selector comprises a controller to sense whether the second video signal generator is connected to the computer, and to output the first video signal through the first output port when the second video signal generator is connected to the computer.

11. The computer according to claim 10, further comprising a motherboard, and an interface that is provided in the motherboard, to which the second video signal generator is detachably connected, and generates an attachment/detachment sensing signal according to whether the second video signal generator is connected to the interface, wherein
the controller determines whether the second video signal generator is connected to the interface on the basis of the attachment/detachment sensing signal generated by the interface, and controls the first video signal to be outputted through the first output port when the second video signal generator is connected to the interface.

12. A graphic card detachably connected to the computer, comprising:
an output port;
an interface having a plurality of signal pins for communicating with the computer; and
a graphic controller that generates first and second videos signals different in format from each other on the basis of data transmitted from the computer through the interface, outputs the first video signal through the output port, and outputs the second video signal to the computer through at least one signal pin among a plurality of signal pins provided in the interface.

13. The graphic card according to claim 12, wherein the interface supports an accelerated graphics port (AGP) interface.

14. The graphic card according to claim 13, wherein the second video signal is outputted from the graphic controller to the computer through at least one signal pin among the plurality of signal pins provided in the interface except the signal pins for data communication using the AGP interface.

15. The graphic card according to claim 13, wherein the first video signal has one format of an analog-type and a digital-type, and the second video signal has the other format.

16. A computer method, comprising:
generating a first video signal having a predetermined format and generating a second video signal having the same format as the generated first video signal; and
outputting at least one of the generated first video signal and/or the generated second video signal through an output port when the generated second video signal is connected to a computer.

17. A method, comprising:
mounting an external graphic card to a computer;
outputting an interface signal through a first port of said external graphic card; and
generating a video signal in a controller on a motherboard and outputting said video signal through a second port of said computer.
